(19) United States
(12) Patent Application Publication
(10) Pub. No.: US 2005/0074313 A1
(43) Pub. Date: Apr. 7, 2005

(54) Facility and method for manufacturing semiconductor device and stocker used in the facility

(76) Inventors: Song-Won Kang, Kyungki-do (KR); Sun-Yong Lee, Seoul (KR); Sung-Il Kim, Seoul (KR); Myung-Hwan Shin, Kyungki-do (KR); Chi-Woon Jang, Kyungki-do (KR)

Correspondence Address: MARGER JOHNSON & McCOLLOM, P.C., 1030 S.W. Morrison Street, Portland, OR, 97205, US

(21) Appl. No.: 10/956,802

(22) Filed: Oct. 1, 2004

(30) Foreign Application Priority Data
Oct. 2, 2003 (KR) 2003-68799

(51) Int. Cl. B65G 67/00

(52) U.S. Cl. 414/222.01

(57) ABSTRACT

A facility for manufacturing a semiconductor device is provided. The facility includes a process room for performing a predetermined process on a wafer, and a stocker for keeping a FOUP receiving the wafers on which the process has been completely performed. The FOUP is filled with nitrogen gas and stored in the stocker. A sealing member is fixed on a pedestal in the stocker so as to close the hole penetrating the FOUP placed on the pedestal.

### BACKGROUND OF THE INVENTION

This application claims priority from Korean Patent Application No. 2003-68799, filed on Oct. 2, 2003, in the Korean Intellectual Property Office, the disclosure of which is incorporated herein in its entirety by reference.

### FIELD OF THE INVENTION

The present invention relates to a facility and a method for manufacturing a semiconductor device and more particularly, to a stocker for keeping a container for containing a semiconductor substrate and a facility using the stocker and a method thereof.

### DESCRIPTION OF THE RELATED ART

To manufacture semiconductor devices, various processes such as deposition processes, etching processes, photolithography processes, cleaning processes, ion implanting processes and the like are performed. A facility used for manufacturing semiconductor devices includes a plurality of process rooms for performing the above processes. Wafers as semiconductor substrates are received in a container and transferred to the above-mentioned process rooms. The container receiving wafers which a variety of processes have been completed on is kept in a stocker. Recently, as the diameter of the wafers has increased from 200 to 300 mm, the container is used not only when the wafers are transferred among facilities and are kept but also when a process is proceeding. A front open unified pod (hereinafter, referred to as FOUP) 10a that is a sealing type wafer container for protecting wafers therein from foreign material in air or chemical contaminants is usually used.

The above-mentioned FOUP includes a front open body and a door for opening and closing the front of the body. A hole is made penetrating a side of the body such that internal pressure of the FOUP is controlled when the door is opened or closed. However, when the FOUP containing the wafers is kept in the stocker, ozone or particles remaining in the stocker are introduced into the FOUP through the hole. Since the ozone remains in the FOUP until the FOUP is transferred to a facility for performing next processes, the remaining ozone causes a natural oxide layer to be formed on the wafers in the FOUP. This oxide layer negatively affects the electrical characteristics of a semiconductor chip.

Embodiments of the invention address these and other limitations in the prior art.

### SUMMARY OF THE INVENTION

Accordingly, the disclosure is directed to a facility and a method for manufacturing a semiconductor device and a stocker used in the facility that substantially obviates one or more limitations and disadvantages of the prior art.

It is a feature of the disclosure to provide a facility and a method for manufacturing a semiconductor device, which prevents ozone or particles from being introduced into a container for receiving a wafer.

It is another feature of the disclosure to provide a facility and a method for manufacturing a semiconductor device, which prevents ozone or particles from being introduced from a stocker into a container when the container is kept in the stocker.

Additional advantages and features of the disclosure will be set forth in part in the description which follows and in part will become apparent to those having ordinary skill in the art upon examination of the following or may be learned from practice of the invention. The objectives and other advantages of the disclosure may be realized and attained by the structure particularly pointed out in the written description and claims hereof as well as the appended drawings.

In an embodiment of the present invention, there is provided a method for manufacturing a semiconductor device, including the processes of: performing a predetermined process on semiconductor substrates in a process room; loading the semiconductor substrates into a container; filling the container with inert gas; and closing a hole penetrating the container.

It is to be understood that both the foregoing general description and the following detailed description of embodiments of the present invention are exemplary and explanatory and are intended to provide further explanation of the invention as claimed.

### BRIEF DESCRIPTION OF THE DRAWINGS

The accompanying drawings, which are included to provide a further understanding of the invention, illustrate embodiments of the invention and together with the description serve to explain the principle of the invention. In the drawings:

FIG. 1 is a flow diagram showing a semiconductor manufacturing facility according to an embodiment of the present invention.

FIG. 2 is a perspective view of a FOUP employed an embodiment of the present invention.

FIG. 3 is an enlarged sectional of area of ‘A’ of FIG. 2.

FIG. 4 is a plan schematic view of the process room 20 of FIG. 1.

FIG. 5 is an enlarged view of the FOUP 10.

FIG. 6 is a view in the direction of arrow ‘B’ of FIG. 5.

FIG. 7 is a partially fragmentary perspective view of a stocker a portion of which is taken according to an embodiment of the present invention.

FIG. 8 is a perspective view of a sealing member.

FIG. 9 shows a sealing member fixed on a pedestal.

FIG. 10 is a view of a pedestal.

FIG. 11 is a flowchart of a method of manufacturing a semiconductor device using the facility.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention. Accordingly, the figures of the elements of drawings may be exaggerated to make clear illustration.

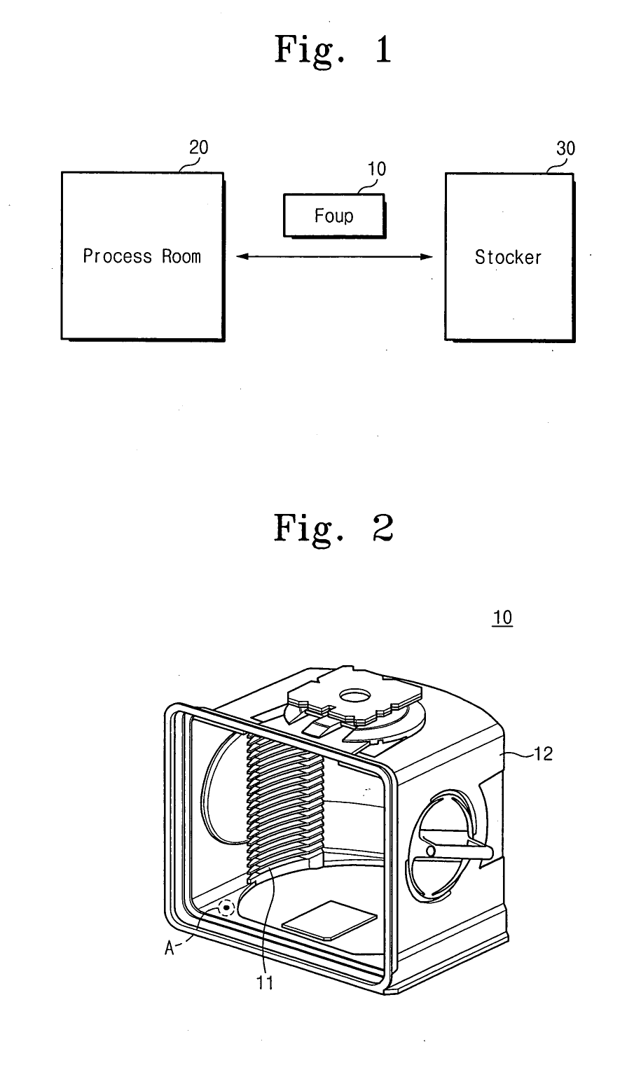

An embodiment of the present invention will be described in detail with reference to FIGS. 1 to 11.

FIG. 1 is a flow diagram showing a semiconductor manufacturing facility according to an embodiment of the present invention. Referring to FIG. 1, the facility includes a process room 20, a stocker 30 and a container 10. The process room 20 cleans wafers. Selectively, the process room 20 may be a process room performing other processes such as deposition processes or etching processes. The container 10 is a vessel for receiving wafers and may be a FOUP that is a sealing type wafer carrier so as to protect a wafer from chemical contamination or foreign material in air during transferring. The wafers are received in FOUP 10 and transferred to and from the process room 20.

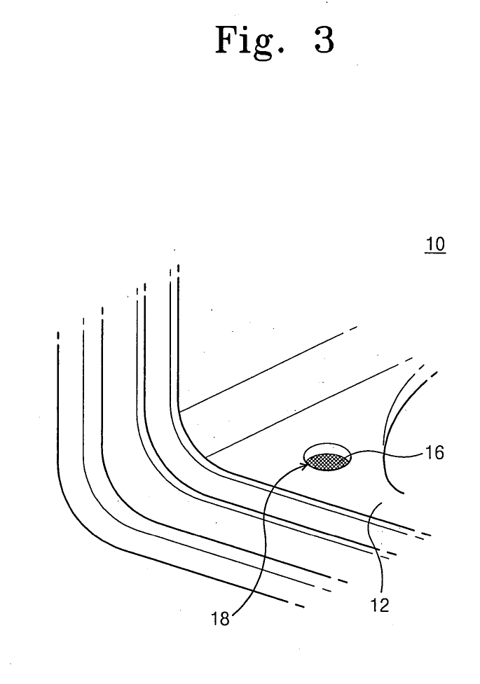

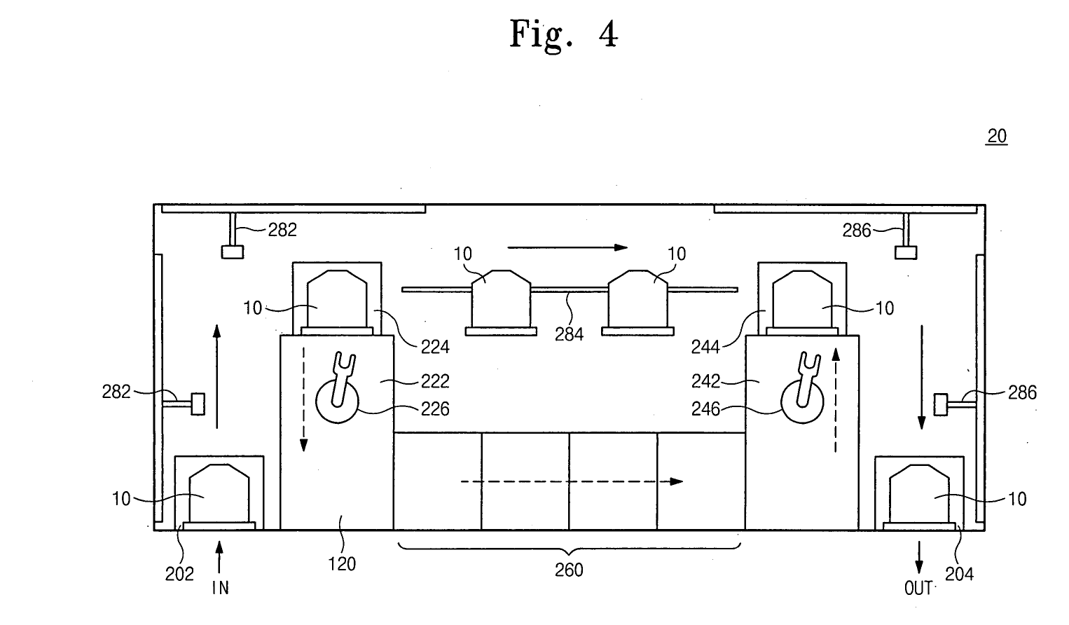

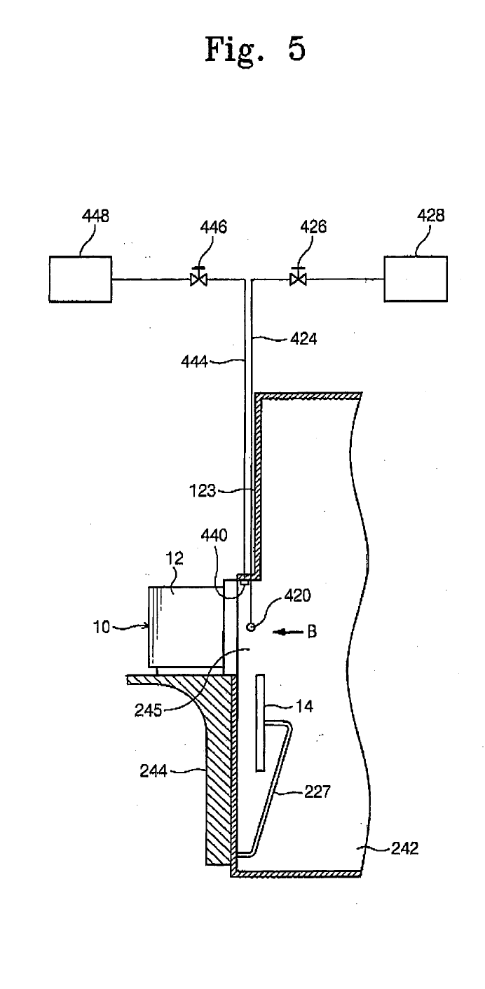

FIG. 2 is a perspective view of a FOUP employed in an embodiment of the present invention. FIG. 3 is an enlarged section of area ‘A’ of FIG. 2. In FIG. 2, a door 14 of FOUP is omitted. The FOUP 10 includes a body 12 whose front portion is open and a door (depicted as 14 in FIG. 5). Slots 11 into which wafers are inserted are formed in parallel on an inner side of the body 12. A hole is made penetrating a bottom side of the body 12. The hole 18 is used to control inner pressure of the FOUP 10 when the door 14 is opened and closed by a door opening and closing unit 227 installed in a frame (depicted as 222 and 242 in FIG. 4) to be described later. As shown in FIG. 3, a filter 16 is inserted into the hole 18 so as to prevent external air and particles from being introduced into the FOUP 10.

FIG. 4 is a plan schematic view of the process room 20 of FIG. 1. In FIG. 4, a solid line is a path along which a FOUP 10 is moved and a dotted line is a path along which a wafer is moved. Referring to FIG. 4, a plurality of process baths 260 for cleaning the wafers are disposed at the center of the process room 20. Each of the process baths 260 cleans the wafers transferred into the process bath 260 by means of chemicals and cleaning liquid such as deionized water. A first frame 222 is disposed on a side of the process bath 260 and interfaces between the FOUP 10 and the process bath 260. A first station 224 is coupled with the front of the first frame 222, and the FOUP 10 receiving the wafers is placed on the first station 224. A second frame 242 is disposed on the other side of the process bath 260 and interfaces between the FOUP 10 and the process bath 260. A second station 244 is coupled with the front of the second frame 242, and the FOUP 10 receiving the wafers is placed on the second station 244. A door opening and closing unit 227 for opening and closing the door 14 of the FOUP is installed in each frame. Transfer robots 226 and 246 are disposed to transfer wafers between the process bath 260 and the FOUP 10 placed on the station 224 or 244.

A transfer system for transferring the FOUP 10 is installed in the process room 20. The transfer system includes a plurality of transfer units 282, 284 and 286. A first transfer unit 282 transfers the FOUP coming into the process room 20 onto the first station 224. A second transfer unit 284 transfers the empty FOUP 10 from which the wafers have been unloaded onto the second station 244. A third transfer unit 286 transfers the FOUP into which the wafers are loaded from the second station 244 to the outside of the process room 20. Although not shown, another transfer unit for transferring the wafers in the FOUP to each process room may be further provided. Each of the transfer units 282, 284, 286 may be an overhead transfer (hereinafter, referred to as OHT), an overhead conveyer (hereinafter, referred to as OHC), an automatic guided vehicle (hereinafter, referred to as AGV or RGV), or the like.

After the completely cleaned wafers are transferred into the FOUP 10 and the door 14 of the FOUP 10 is closed, natural oxide layers are formed on the wafers by the air introduced into the FOUP 10. To prevent the natural oxide layers from being formed, a gas injector and an air blocker are installed in the facility. The air blocker prevents air from being introduced from the frame to the FOUP 10 and the gas injector fills the FOUP 10 with inert gas.

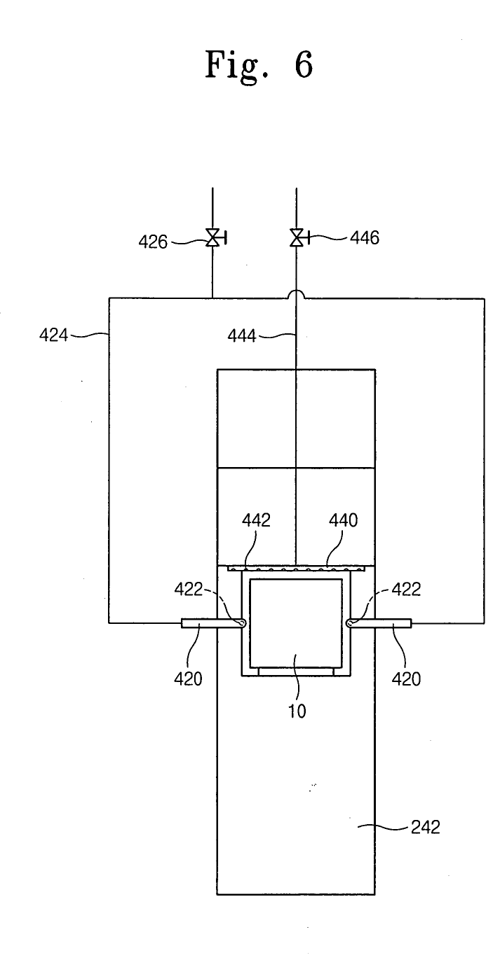

FIG. 5 is an enlarged view of the FOUP 10. FIG. 6 is a view in the direction of arrow ‘B’ of FIG. 5. Referring to FIGS. 5 and 6, the second frame 242 is provided with an opening 245 through which wafers are transferred from the FOUP 10 to the second frame 242. The air blocker is installed on the upper portion of the opening 245. The air blocker includes a block nozzle 440 and a supply pipe 444. The block nozzle 440 has a plurality of holes downwards. The supply pipe 444 is provided with an opening and closing valve 426 and supplies the inert gas from a gas storage 428 to the block nozzle 440. The inert gas acts a blocking film at the front of the opening 245 so that air is prevented from being introduced from the second frame 242 into the FOUP 10. The gas injector includes an injection nozzle 422 and a supply pipe 424. The injection nozzle 422 is installed to direct from both sides of the opening 245 to the outside of the opening 245 (the inside of the FOUP 10). The supply pipe 424 has an opening and closing valve 446 for supplying the inert gas from the gas storage 428 to the injection nozzle 422. The inert gases injected from the injection nozzle 422 and the blocking nozzle 442 may be nitrogen gas. According to an embodiment of the present invention, since the FOUP 10 in the process room 20 is filled with nitrogen gas, oxygen or ozone does not exist in the FOUP 10. Accordingly, the natural oxide layer is prevented from being formed on a wafer.

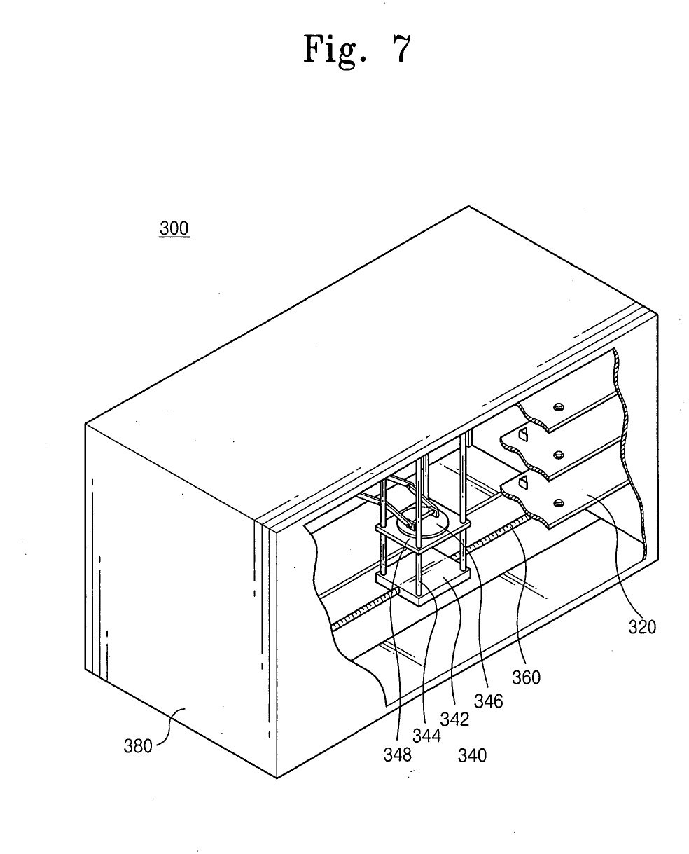

In the present embodiment, the gas injector is installed in the second frame 242. However, it is merely an example. The gas injector may be installed on a transfer path along which the FOUP 10 is transferred or may be separately installed outside the process room 20. The FOUP 10 receiving the completely cleaned wafers is kept in the stocker 30 until a next process. FIG. 7 is a partially fragmentary perspective view of a stocker according to an embodiment of the present invention and a portion of the stocker is taken out here. Referring to FIG. 7, a stocker 30 has a space for keeping a FOUP 10 inside, and includes a body 380, a pedestal 320, a transfer unit 340 and a sealing member 500. The body 380 has a shape of cube to seal the inside from the outside, and is provided with a filter (not shown) on the outer side so as to prevent particles or ozone from being introduced from the outside. At both sides in the body 380, pedestals 320 upon which FOUPs 10 are placed are stacked. At the center of thee body 380, a transfer unit 340 is disposed to transfer the FOUP 10 and load and unload the FOUP 10 onto and from the pedestal 320.

Additionally, an upper plate is positioned to face to a lower plate 342. A guide rail 360 for guiding the lower plate 342 and the upper plate are installed on the bottom surface and the upper surface of the body 380. A plurality of guide rods 344 are installed between the upper plate and the lower plate 342. The moving plate 348 moves up and down along the guide rods 344. The rotating transfer arm 346 is installed on the moving plate 348. Although not shown, a port may be installed at a side of the body 380 and has an inlet through which the FOUP 10 is transferred into the stocker 30 and an outlet through which the FOUP 10 is transferred from the stocker 30.

When the FOUP is being transferred from the process room 20 to the stocker 30 and when the FOUP is being kept in the stocker 30, the nitrogen gas filled in the FOUP 10 may be vented through the hole 18 penetrating the FOUP 10 to the outside of the FOUP 10 and the external particles or ozone (O₃) may be introduced into the FOUP 10 through the hole 18. In addition, even in the stocker, ozone can still get into the FOUP 10 because a small amount of ozone exists in the stocker 30 and the filter 16 is not adequate to keep all of the ozone out of the FOUP 10. The ozone may cause a natural oxide layer to be formed on the wafer. The sealing member 500 closes the hole 18 penetrating the FOUP 10 so as to prevent nitrogen gas from being vented out thereby preventing the particles or the ozone from being introduced into the FOUP 10.

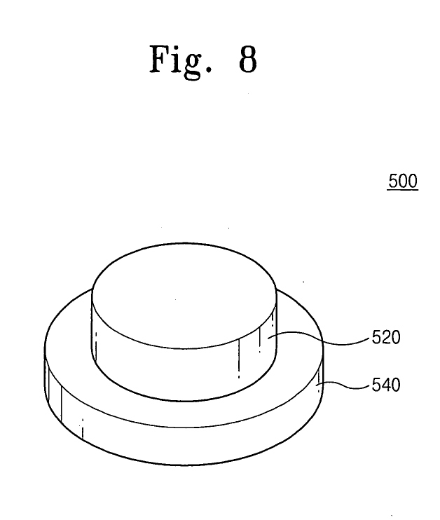

FIG. 8 is a perspective view of a sealing member. Referring to FIG. 8, the sealing member 500 includes a circular header 540 and a circular insertion unit 520 extending from the header 540 upwards. The header 540 has cross-sectional area larger than the insertion unit 520. The insertion unit 520 has a shape and a size corresponding to the hole 18 so as to be inserted into the hole 18 penetrating the FOUP 10. The sealing member 500 may be made of rubber. Preferably, the sealing member 500 may be made of silicon. When nitrogen is filled in the FOUP 10 and a door 14 of the FOUP is closed, the insertion unit 520 of the sealing member is inserted into the hole 18 penetrating the FOUP 10 to seal the inside of the FOUP 10 from the outside.

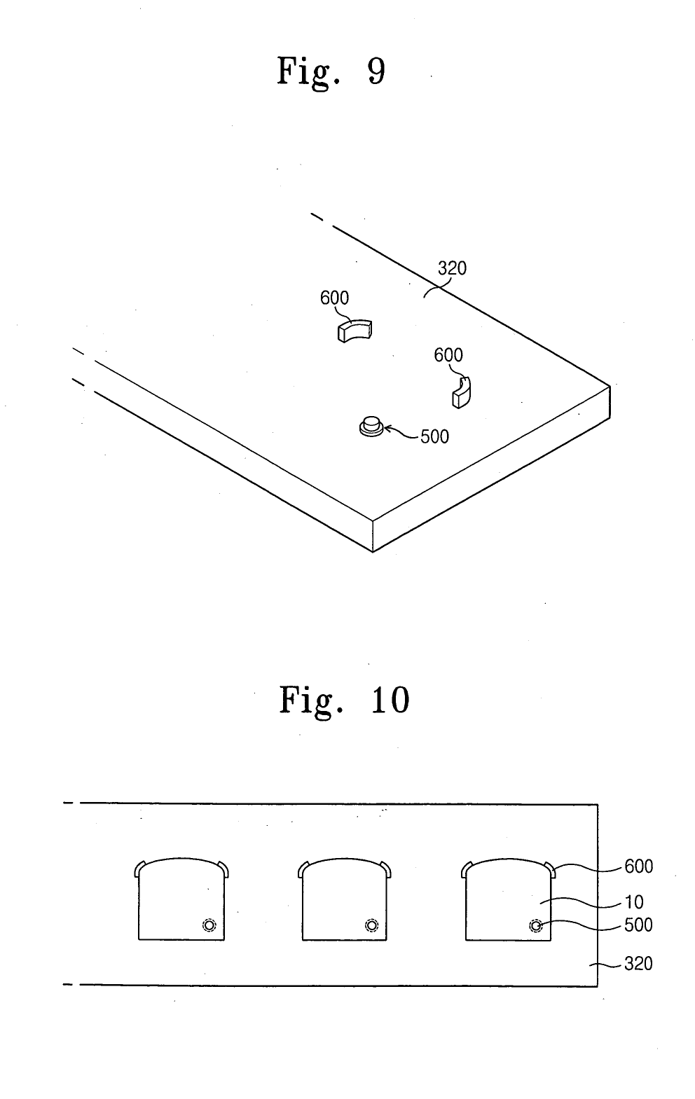

After the door 14 of the FOUP is closed, it is desirable that the hole 18 penetrating the FOUP 10 is closed as soon as possible. With automation of a process of manufacturing a semiconductor device, it is desired that the hole 18 is opened and closed by the sealing member 500 not manually but automatically. FIGS. 9 and 10 show examples that the hole 18 is automatically opened and closed by the sealing member 500.

FIG. 9 shows a sealing member fixed on a pedestal. FIG. 10 is a view of a pedestal showing the states of FOUP that is placed on the pedestal. Referring to FIG. 9, a sealing member 500 and guides 600 for guiding the FOUP 10 to a proper location are fixed on the pedestal 320. The guides 600 are installed to project from pedestal 320 upwards such that the guides 600 surround a corner of the bottom of the FOUP 10. The sealing member 500 is installed to face the hole penetrating the FOUP 10 when the FOUP 10 is normally placed on the pedestal 320. When the FOUP 10 is transferred to the stocker and placed on the pedestal 320, the insertion unit 520 of the sealing member is inserted into the hole 18 penetrating the FOUP 10 to close the hole 18, thereby completely sealing the FOUP 10. Then, if the FOUP 10 is lifted up from the pedestal 320, the insertion unit 520 of the sealing member is removed from the hole 18.

Therefore, according to this embodiment of the present invention, when the FOUP 10 is kept in the stocker 30, since the FOUP 10 is sealed from the outside, the nitrogen gas filled in the FOUP 10 can be prevented from being leaked out and also the ozone or the particles remaining in the stocker 30 can be prevented from being introduced into the FOUP 10.

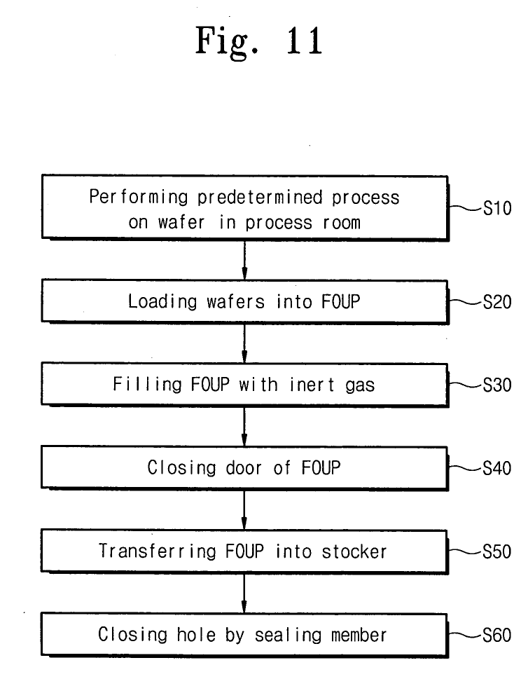

FIG. 11 is a flowchart of a method of manufacturing a semiconductor device using the facility. Referring to FIG. 4 again, the FOUP 10 receives wafers and is transferred into the process room 20 through an input port 202. The FOUP 10 is placed on the first station 224 by the first transfer unit 282. The door 14 of the FOUP 10 is opened by the door opening and closing unit 227. The wafers in the FOUP 10 are unloaded from the FOUP 10 by the transfer robot 226, and then are transferred to the process bath 260. After the door 14 is closed, the FOUP 10 is placed on the second station 242 by the second transfer unit 284. The wafers are cleaned by means of chemicals or cleaning agent (process S10). The completely cleaned wafer is transferred into the FOUP 10 by the transfer robot 246 disposed in the second frame 242 (process S20). While the wafers are transferred, nitrogen gas is projected downwards from the block nozzle 440 installed in the second frame 242 so that air is prevented from being introduced from the second frame 242 into the FOUP 10. If all the wafers are transferred into the FOUP 10, the injection nozzle 420 injects nitrogen gas to fill the FOUP 10 with the nitrogen gas (process S30). Then, the door 14 of the FOUP 10 is closed and the FOUP 10 is transferred by the third transfer unit 286 to the outside of the process room 20 through an output port 204 (process S40).

Then, the FOUP 10 is transferred to the stocker 30, and then is kept in the stocker 30 until a next process. The FOUP 10 transferred into the stocker 30 is transferred to a predetermined position on the pedestal 320 by the transfer unit 340 (process S50). When the FOUP 10 is placed on the pedestal 320, the insertion unit 520 of the sealing member installed on the pedestal 320 is inserted into a hole 18 penetrating the FOUP 10 (process S60). The FOUP 10 is sealed from the outside and kept in the stocker 30.

According to this embodiment of the present invention, since the FOUP is filled with inert gas and is transferred and kept, a natural oxide layer is prevented from being formed on the wafer in the FOUP.

Further according to this embodiment of the present invention, ozone or particles are prevented from being introduced from the stocker into the FOUP through a hole penetrating the FOUP.

It will be apparent to those skilled in the art that various modifications and variations can be made in this embodiment of the present invention. Thus, it is intended that the scope of the appended claims and their equivalents describe the limits of the invention.

1. A facility which manufactures a semiconductor device, the facility including a container defining a hole and the container for receiving semiconductor substrates, the facility comprising:
a process room for performing a predetermined process on the semiconductor substrates; and
a stocker for receiving the processed semiconductor substrates within the container, the stocker comprising a sealing member for closing the hole.

2. The facility of claim 1, further comprising a gas injector for introducing gas into the container containing the processed semiconductor substrates on which said predetermined process has been performed.

3. The facility of claim 1, wherein the sealing member is fixed on a predetermined portion of the support surface such that the hole is closed when the container is located on the predetermined portion of the support surface.

4. The facility of claim 2, wherein the sealing member comprises:
a header attached to the support surface; and
an insertion unit extending upwardly from the header which inserts into the hole.

5. The facility of claim 2, wherein the stocker comprises a guide for directing the container for placement onto a predetermined portion of the support surface.

6. The facility of claim 1, wherein the sealing member is formed of silicon.

7. The facility of claim 1, wherein a filter is inserted into the hole.

8. The facility of claim 2, wherein the gas from the gas injector is an inert gas.

9. The facility of claim 2, wherein the gas injector is located in the process room.

10. The facility of claim 1, wherein the container is a FOUP (front open unified pod).

11. The facility of claim 1, wherein a side of the container further defines the hole.

12. A stocker for receiving semiconductor substrates, a contained located within said stocker containing said semiconductor substrates, the container further defining a hole, the stocker comprising:
a support surface within the stocker on which the container is located; and
a sealing member fixed on a predetermined portion of the support surface, for closing the hole when the container is located on the support surface.

13. The stocker of claim 12, further comprises:
a guide for guiding the container so as to allow the container to be placed on the predetermined portion of the support surface.

14. The stocker of claim 12, wherein the sealing member is formed of silicon.

15. The stocker of claim 12, wherein the container is a FOUP.

16. The stocker of claim 12, wherein the container includes an inert gas and transferred to the stocker so as to prevent a natural oxide layer from being formed on the semiconductor substrates in the container.

17. The stocker of claim 12, further comprising a transfer unit, for loading and unloading the container onto and from the predetermined portion of the support surface.

18. The stocker of claim 12, wherein the support surface comprises a pedestal located within the stocker.

19. A method for manufacturing a semiconductor device, comprising the steps of:
performing a predetermined process on semiconductor substrates;
loading the processed semiconductor substrates into a container defining a hole;
introducing an inert gas into the container; and
closing the hole.

20. The method of claim 19, further comprising the step of:
while the hole is open, transferring the container from the process room and transferring the container into a stocker; and
wherein, the hole is closed when the container is located on a pedestal.

21. The method of claim 19, wherein the container is a FOUP.

22. The method of claim 19, wherein the predetermined process is performed in a process room.

23. The method of claim 19, wherein the hole is located in a side of the container.
